(19) United States
(12) Patent Application Publication
(10) Pub. No.: US 2020/0009413 A1
(43) Pub. Date: Jan. 9, 2020

(54) BAR APPARATUS FOR REMOVABLE ATTACHMENT TO A SUPPORT SURFACE

(71) Applicant: JBody, LLC, Atlanta, GA (US)

(72) Inventors: Joseph M. Berklund, Atlanta, GA (US); Julie Weisman Berklund, Atlanta, GA (US)

(21) Appl. No.: 16/483,328

(22) PCT Filed: Feb. 5, 2018
(86) PCT No.: PCT/US18/16823

§ 371 Date: Aug. 2, 2019

Related U.S. Application Data
(60) Provisional application No. 62/454,485, filed on Feb. 3, 2017.

(51) Int. Cl. A63B 1/00; F16B 47/00

(52) U.S. Cl. CPC A63B 1/00; A63B 2023/006; F16B 47/006

(57) ABSTRACT

The presently disclosed subject matter is directed to a bar apparatus that can be removably attached to a support surface. The disclosed apparatus, in particular embodiments, includes a support bar and at least two support members configured to securely (but removably) attach the support bar to a surface, such as a wall. The present disclosure is further directed to a method of installing a bar apparatus by, in one embodiment, attaching a first end of a support bar to a surface, rotating the bar apparatus about a rotating joint, and attaching a second end of the support bar to the surface.

### CROSS REFERENCE TO RELATED APPLICATIONS

This application is a national stage entry of, and claims the benefit of and priority to, International Patent App. No. PCT/US18/16823, filed on Feb. 5, 2018, and entitled “BAR APPARATUS FOR REMOVABLE ATTACHMENT TO A SUPPORT SURFACE”, which claims the benefit of and priority under 35 U.S.C. § 119 to U.S. Provisional Patent Application No. 62/454,485, filed on Feb. 3, 2017, and entitled “BAR APPARATUS FOR REMOVABLE ATTACHMENT TO A SUPPORT SURFACE,” the disclosures of which are incorporated by reference in their entireties as if the same were fully set forth herein.

### TECHNICAL FIELD

The presently disclosed subject matter relates to an adjustable bar apparatus for removable attachment to a support surface and to methods of making and using the same.

### BACKGROUND

Improved understanding of disease and how the body works has resulted in increased longevity in humans. As such, more and more individuals strive to incorporate some type of exercise into their daily routine. One type of exercise seeing increased popularity is bane exercise, which integrates a fat-burning format of interval training with muscle-shaping isometrics to quickly and safely reshape the entire body. It is standard in barre studios to have bars (known as banes) mounted along the wails for enabling users to strengthen muscles, increase extension, improve flexibility, and help with balance. However, barre classes are typically limited to studios with large enough spaces that can accommodate barres mounted along the walls. Further, home fitness through the use of applications and at-home instruction is growing, and the need to have easy to use equipment to facilitate such applications would be beneficial.

### SUMMARY

The present apparatus and related methods relate to a bar apparatus for removable attachment to a support surface. In particular embodiments, the bar apparatus includes a support bar having a first end and a second end and one or more suction cup assemblies. In some embodiments, the bar apparatus includes a cup housing, a suction member, a lever that disposes the cup housing against the suction member when actuated to attach the assembly to the support surface and one or more support brackets that connect the support bar to the one or more suction cup assemblies. In at least one embodiment, each support bracket is operatively connected to the support bar and includes a rotatable joint between the support bar and the suction cup assembly, allowing a user to install the bar assembly (potentially without assistance).

As will be understood from discussions herein, a bar assembly for barre-style exercises may need to be of a particular length (e.g., 3 feet) and such a bar assembly may be challenging for a user to install without assistance of another person. As such, in various embodiments, the apparatus disclosed herein includes at least one rotating joint, enabling a user to install one or more suction cups operatively connected a first end of a support bar to a wall, rotate the support bar about the rotating joint such that the support bar is level with a floor, and install one or more suction cups operatively connected to a second end of the support bar, thereby attaching the support bar to the wall substantially level to the floor without the assistance of another person.

In one embodiment, a bar apparatus for removable attachment to a support surface, the apparatus comprising: a. a support bar having a first end and a second end; b. two or more suction cup assemblies, each suction cup assembly comprising: i. a cup housing; and ii. a suction member; iii. a lever that disposes the cup housing against the suction member when actuated to attach the assembly to a support surface; and c. one or more support assemblies that operatively connect the support bar to the two or more suction cup assemblies, wherein at least one support assembly comprises: i. a rotating joint between the support bar and the two or more suction cup assemblies; and ii. a support bracket that operatively connects the rotating joint to the two or more suction cup assemblies.

In one embodiment, a method for installing a removable bar assembly comprising: placing a suction cup of a first support assembly upon a surface, with a support bar in a first position; actuating a lever operatively coupled to the first support assembly suction cup thereby causing air to be evacuated from the first support assembly suction cup and adhering the first support assembly suction cup to the surface; rotating the support bar to a second position via a joint operatively connecting the support bar to the first support assembly suction cup; and actuating a lever of a second support assembly thereby causing air be evacuated from a suction cup of the second support assembly and adhering a second suction cup to the surface, thereby adhering the support bar to the surface in the second position.

According to one aspect of the present disclosure, the apparatus, further comprising a leveling device. Furthermore, the apparatus, wherein the leveling device is embedded within the support bar. Moreover, the apparatus, wherein the support bar is hollow. Further, the apparatus, wherein the support bar is about 1-5 feet in length, 1-5 inches in diameter, or both. Additionally, the apparatus, wherein the suction member and cup housing are substantially circular in shape. Also, the apparatus, wherein the support bracket comprises a substantially v-shaped outer perimeter.

According to one aspect of the present disclosure, the apparatus, wherein the support bracket comprises a substantially u-shaped interior. Furthermore, the apparatus, wherein the support bracket is constructed from wood, metal, rigid plastic, or combinations thereof. Moreover, the apparatus, wherein the rotating joint is movable relative to the suction cup assembly. Further, the apparatus, wherein the rotating joint facilitates rotation of the support bar 360 degrees relative to the suction cup assembly. Additionally, the apparatus, wherein the one or more support assemblies are positioned proximate the first end or the second end of the support bar. Also, the apparatus, wherein the at least one or more support assemblies comprise two support assemblies.

According to one aspect of the present disclosure, the method, wherein: the first support assembly comprises more than one suction cup; and the method further comprises actuating one or more levers operatively coupled to the first support assembly one or more suction cups, thereby causing air to be evacuated from the first support assembly one or more suction cups and adhering the first support assembly one or more suction cups to the surface. Furthermore, the method, wherein: the second support assembly comprises more than one suction cup; and the method further comprises actuating one or more levers operatively coupled to the second support assembly one or more suction cups, thereby causing air to be evacuated from the second support assembly one or more suction cups and adhering the second support assembly one or more suction cups to the surface. Moreover, the method, wherein the removable bar assembly further comprises a leveling device embedded within the support bar. Further, the method, wherein rotating the support bar to the second position further comprises determining, via the leveling device, that the support bar is parallel to the ground. Additionally, the method, wherein the first position is approximately 90 degrees relative to the second position. Also, the method, further comprising the step of testing the installed removable bar assembly to ensure that the installed removable bar assembly supports a particular amount of weight.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a perspective view of an exemplary bar assembly according to one embodiment of the present disclosure.

FIG. 2 is a side view of an exemplary bar assembly according to one embodiment of the present disclosure.

FIG. 3 is a side view of an exemplary bar assembly according to one embodiment of the present disclosure.

FIG. 4 is a front view of an exemplary bar assembly according to one embodiment of the present disclosure.

FIG. 5 is back view of an exemplary bar assembly according to one embodiment of the present disclosure.

FIG. 6 is top view of an exemplary bar assembly according to one embodiment of the present disclosure.

FIG. 7 is a bottom view of an exemplary bar assembly according to one embodiment of the present disclosure.

FIG. 8 is a perspective view of a bar according to one embodiment of the present disclosure.

FIG. 9 is a perspective view of a support assembly according to one embodiment of the present disclosure.

FIG. 10 is a perspective view of a support assembly according to one embodiment of the present disclosure.

FIG. 11 is a perspective view of a suction cup assembly according to one embodiment of the present disclosure.

FIG. 12 is a perspective view of a lever according to one embodiment of the present disclosure.

FIG. 13 is a side view of an exemplary bar assembly as it is being installed according to one embodiment of the present disclosure.

FIG. 14 is a side view of an exemplary bar assembly as it is being installed according to one embodiment of the present disclosure.

### DETAILED DESCRIPTION

The presently disclosed subject matter can be embodied in many different forms and should not be construed as limited to the embodiments set forth herein; rather, these embodiments are provided so that the disclosure will satisfy applicable legal requirements. Indeed, many modifications and other embodiments of the presently disclosed subject matter will come to mind to one skilled in the art to which the presently disclosed subject matter pertains. Therefore, it is to be understood that the presently disclosed subject matter is not to be limited to the specific embodiments disclosed and that modifications and other embodiments are intended to be included within the scope of the appended claims.

Following long-standing patent law convention, the terms “a,” “an,” and “the” refer to “one or more” when used in the subject application, including the claims. Thus, for example, reference to “an agonist” includes a plurality of agonists, unless the context clearly is to the contrary (e.g., a plurality of agonists), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. Further, the term “about” refers to a range of +/−0.1, 1, 2, 5, 10, 15, or 20% of a stated value. For example, the phrase “about four hours or less” can include 3-5 hours or any time in between.

### Bar Assembly

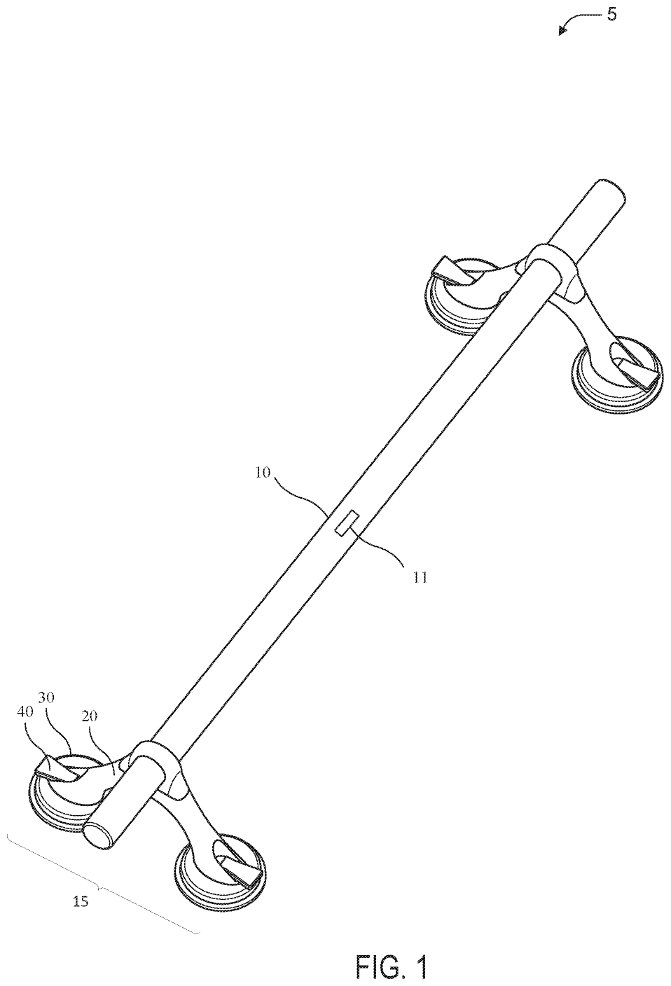

FIGS. 1-7 show a portable bar assembly 5 constructed in accordance with some embodiments of the present disclosure. In particular embodiments, the bar assembly 5 includes a support bar 10 operatively attached to one or more support assemblies 15 configured to securely (but removably) attach the bar 10 to a surface, which, in some embodiments, may be a wall or mirror. As shown in the embodiment in FIG. 1, the one or more support assemblies 15 include a bracket assembly 20 operatively attached to a suction cup assembly 30 and a lever 40. In particular embodiments, the bar assembly 5 further includes a level element 11. Each of the components shown in FIG. 1 will be further discussed below.

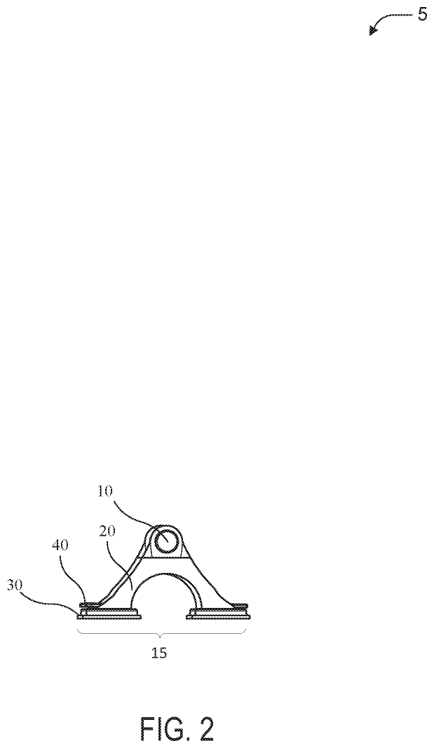

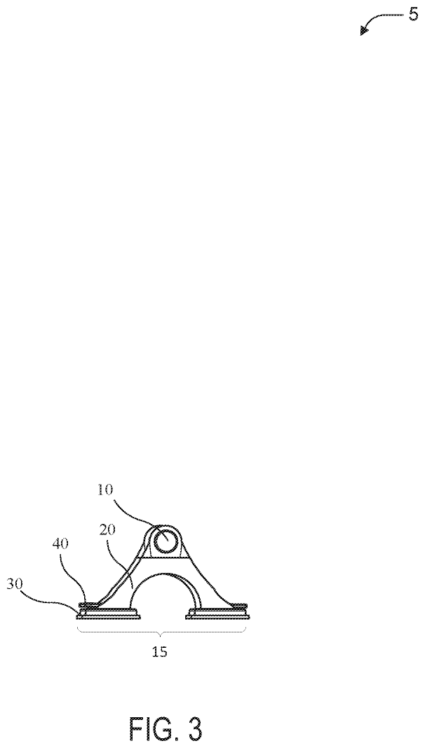

FIGS. 2-3 show side views of the bar assembly 5 according to one embodiment. As shown in FIGS. 2-3, a cross section of the bar 10 is substantially circular. However, in some embodiments, the bar 10 may be another suitable shape, such as substantially oval, substantially rectangular, or the like. Further, the end of the bar 10 (e.g., the end shown in FIGS. 2-3) may include a taper or end cap (taper and/or end cap not shown). In the embodiment shown in FIGS. 2-3, the one or more support assemblies 15 include a bracket assembly 20, which is generally v-shaped (e.g., along an outer perimeter), with a rounded (or u-shaped) cut-out. As also shown in the embodiment of FIGS. 2-3, the lever 40 is in a “locked” position, such that the suction cup 34 is actuated and may be engaged with a surface (e.g., attached to a wall, mirror, or other surface).

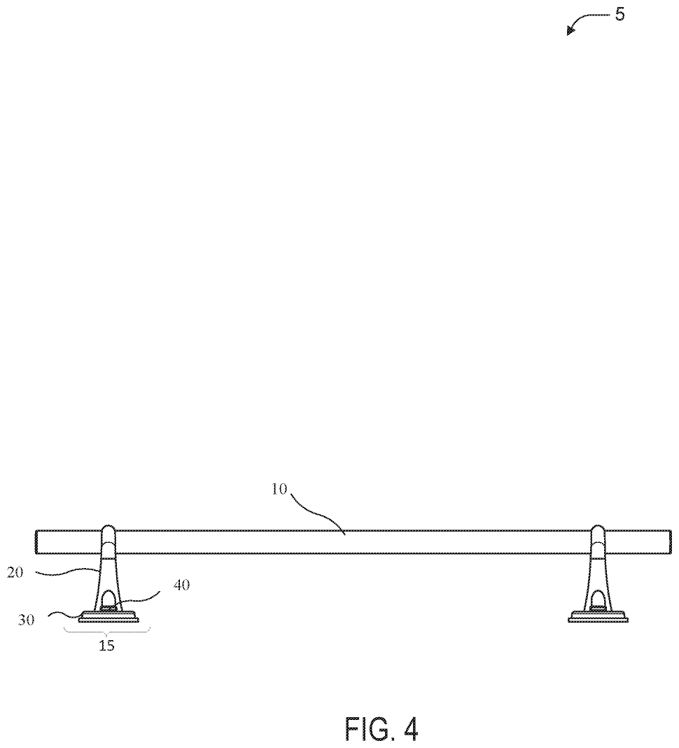

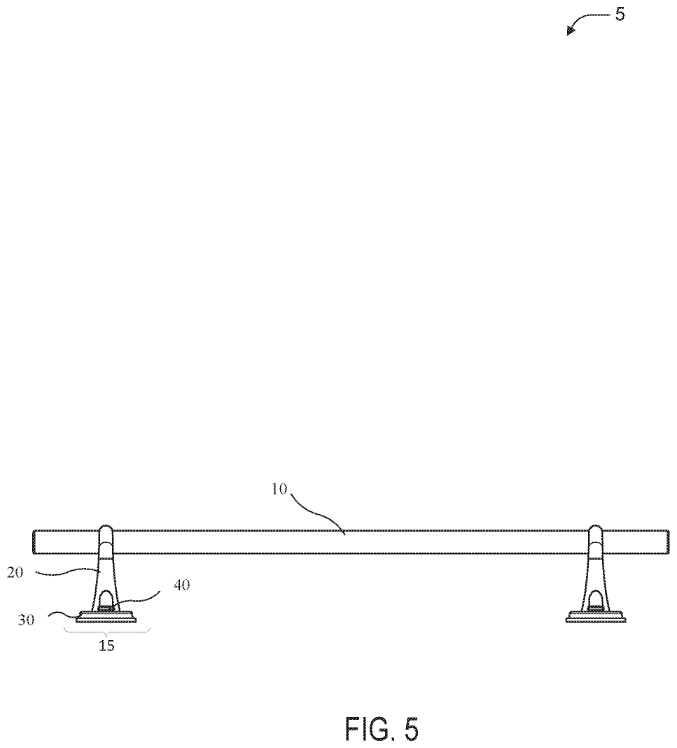

FIGS. 4-5 are front and rear views of the bar assembly 5. In the embodiment shown in FIGS. 4-5, the bar 10 extends through each of the one or more support assemblies 15. In particular embodiments, the bar 10 extends through the one or more support assemblies 15 such that approximately 90% of the length of the bar is between the one or more support assemblies 15 (as measured along a longitudinal length of the bar 10). In some embodiments, the one or more assemblies 15 may be spaced further apart or closer together along the bar 10. As will be understood from discussions herein, having a majority of the bar between the one or more support assemblies 15 may allow a user to more easily complete workouts, routines, or conduct other activities using the bar assembly 15 without hitting or otherwise interfering with the one or more support assemblies 15.

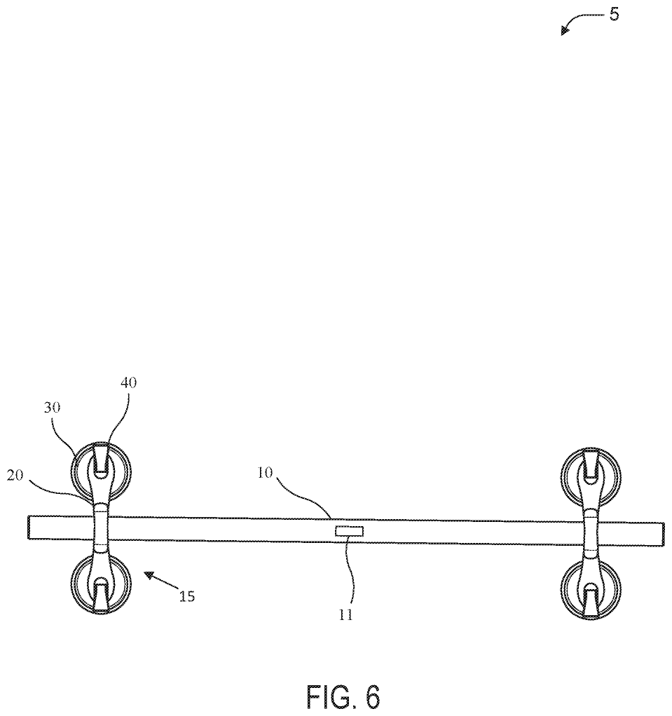

FIG. 6 shows a top view of bar assembly 5 according to one embodiment of the present disclosure. In the embodiment shown in FIG. 6, the one or more support assemblies 15 each include one or more (e.g., 2) suction cup assemblies 30 and one lever 40 per suction cup 34 (e.g., in some embodiments, the bar assembly 5 includes two support assemblies 15, four suction cup assemblies 30, and four levers 40).

In particular embodiments, as shown in FIG. 6, the level element 11 is located substantially in the middle of bar 10. As will be understood, the level element 11 may be in any suitable location along the bar 10 or, in some embodiments, as a part of the one or more support assemblies 15.

As shown in FIG. 6, each of the one or more support assemblies 15 are approximately 40 inches as measured from the center of one suction cup assembly 30 to another suction cup assembly 30 operatively attached to the same support assembly 15. As will be understood from discussions herein, the distance between the center of one suction cup assembly 30 to the center of another suction cup assembly 30 (as measured from center to center in a substantially straight line) may be any suitable distance, such as 12 inches, 14 inches, etc. Further, in particular embodiments the distance between the center line of the bar 10 to a center of a suction cup assembly 30 may vary from one side to another. In particular, in some embodiments, a distance from the centerline of the bar 10 to the center of a first suction cup assembly 30 operatively connected to a particular support assembly 15 may be greater than a distance from the centerline of the bar 10 to a second suction cup assembly 30 operatively attached to the particular support assembly 15.

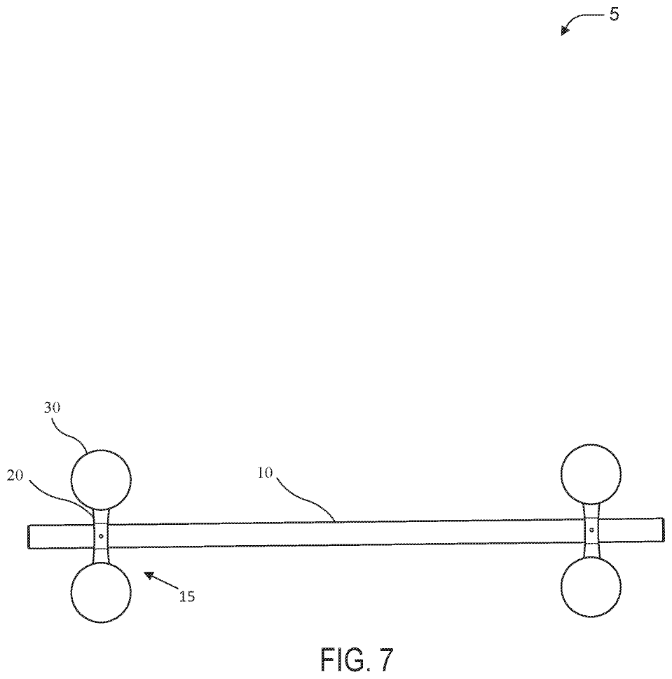

FIG. 7. shows a bottom view of the bar assembly 5 according to one embodiment. In the embodiment shown in FIG. 7, the suction cup assembly 30 is of a greater diameter than the portion of the one or more support assemblies 15 that connects the suction cup assembly 30 to the support assembly 15 (as this feature cannot be seen). Further, in the embodiment of FIG. 7, the lever 40 is not shown as it does extend beyond the diameter of the suction cup assembly 30.

However, as will be understood from discussions herein, the one or more support assemblies 15 may be any suitable shape for supporting the suction cup assemblies 30 and the bar 10. Further, in particular embodiments, the lever 40 may be any suitable shape and/or length. As such, in particular embodiments, the one or more support assemblies 15 may extend further than the diameter of the suction cup assembly 30 and the lever 40 may be seen in a bottom view in additional embodiments of the present apparatus.

### Bar

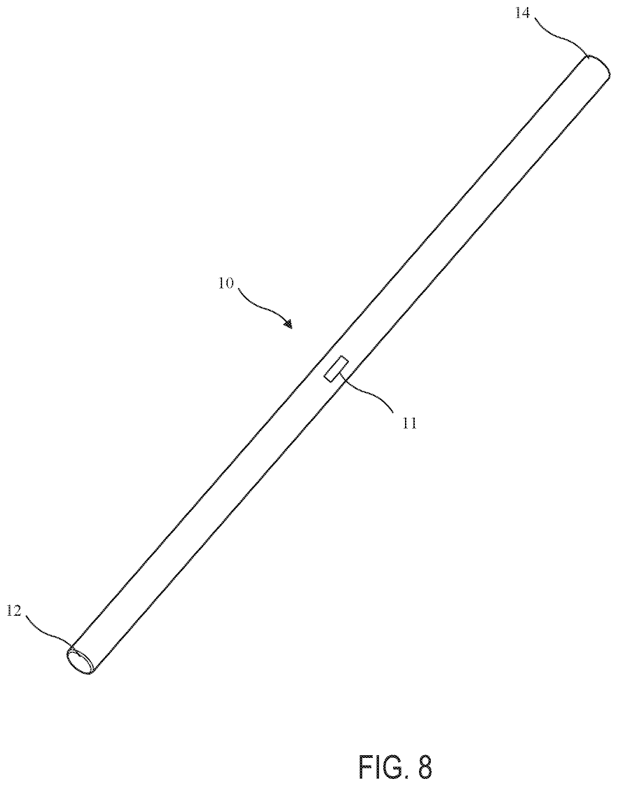

FIG. 8 shows a perspective view of the bar 10 according to one embodiment of the present disclosure. As shown in FIG. 8, the bar 10 includes a linear portion of solid or hollow rigid material, such as wood, metal, and/or hard plastic. The dimensions of the bar 10 can be varied depending on the preference of the user. For example, in some embodiments, the bar can span a length of about 1-5 feet (i.e., 1.0, 1.5, 2.0, 2.5, 3.0, 3.5, 4.0, 4.5, or 5 feet) and a diameter of about 1-5 inches (i.e., 1.0, 1.5, 2.0, 2.5, 3.0, 3.5, 4.0, 4.5, or 5 inches in diameter). It should be appreciated that the dimensions of the bar are not limited and can be larger or smaller than those recited herein above. In some embodiments, the bar is circular in cross-section, although any shape can be used (as discussed above).

In some embodiments, bar 10 includes leveling element 11 that can be used to ensure that the support bar is properly positioned as desired by the user. For example, in some embodiments the user may wish to position the support bar parallel with the floor. The leveling element 11 is not limited to locations as shown in the figures and any suitable leveling device may be operatively attached to, or embedded within the bar 10 (or included in another element of the bar assembly 5, such as, for example, within the one or more support assemblies 15).

As will be understood, the leveling element 11 may be any device to ensure or measure that the bar 10 is level (e.g., to the floor as installed by a user). In some embodiments, the leveling element 11 includes an air bubble in liquid that aligns between markings when level. In various embodiments, the level is embedded within support bar 10.

### Support Assembly

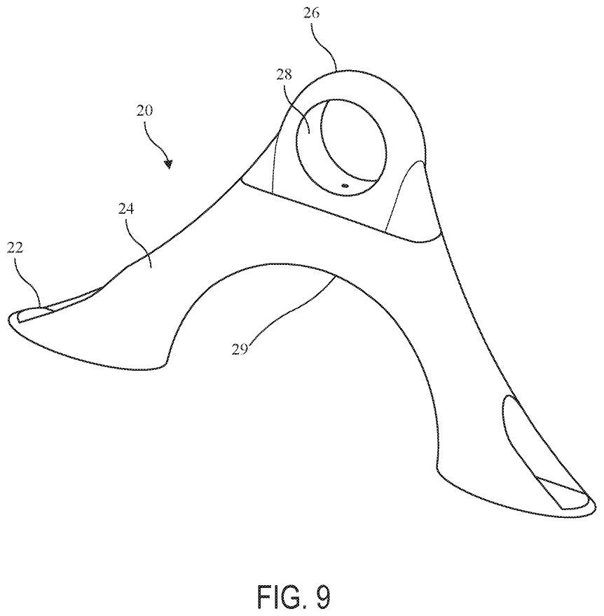

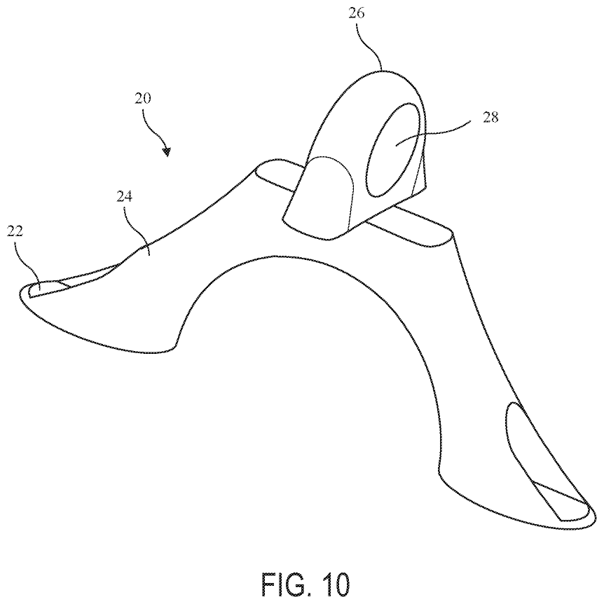

FIGS. 9 and 10 show perspective views of the bracket assembly 20, according to one embodiment of the present disclosure. As shown in the embodiment shown in FIG. 9, the bracket assembly 20 is roughly v-shaped (e.g., along an outer perimeter), with a u-shaped support-assembly-interior 29. This arched design may provide certain structural advantages, including, but not limited to, distributing force along the u-shaped arch of the support-assembly-interior 29.

According to particular embodiments, the bracket assembly 20 includes a support bracket 24 operatively coupled to a bar-housing 26 by a rotatable joint (further discussed below), and defining lever indents 22.

In at least one embodiment, the support bracket 24 includes of two arms and interior joint of the generally v-shaped bracket assembly 20. In various embodiments, each arm of the support bracket 24 connects to a suction cup assembly 30 and a lever 40 via the one or more lever indents 22. The support bracket 24 may be constructed of one continuous piece of solid, rigid material such as wood, metal, and/or hard plastic, or it may be constructed from any suitable material and may include more than one continuous piece of any such material, or a combination(s) of any such material.

According to particular embodiments, the bar-housing 26 defines a substantially circular hole 28 that directly houses and secures the bar 10 therein (e.g., by any suitable mechanism, such as a pin, bolts, screws, press fitting the bar, etc.). The support bracket 24 and bar-housing 26 are operatively connected by a component included of rigid, solid material of sufficient strength to support use of the apparatus 5 as necessary and such that the bar-housing 26 component can be rotated, as illustrated in FIG. 10, which in certain embodiments, facilitates installation of the bar by the user, as further described below.

The dimensions, shape and design of the bracket assembly 20 can be varied for securely connecting to the bar 10, the suction cup assemblies 30, and the suction cup lever 40. Although the embodiment shown in FIGS. 9 and 10 include both the support bracket 24 and the bar housing 26 as separate pieces, in particular embodiments, the bracket assembly 24 may include a single piece of material known or used in the art, including (but not limited to) metal, wood, plastic, and the like. Further, in certain embodiments, the bar 10 and the bar housing 26 may be one integral piece operatively connected to the support bracket 24.

As shown in FIG. 10, the bar housing 26 can be rotated in a manner that facilitates installation of the apparatus 5 by the user as needed, up to 360 degrees, such that a user can install (e.g., attach to a particular surface via the suction cup assembly 30 and lever 40) one support assembly 15 at a time and install the second (or more) support assembly as necessary only after the first support assembly is installed.

As will be understood from discussions herein, the rotatable joint between the support bracket 24 and the bar housing 26 may be lockable in one or more positions by any suitable mechanism. In further embodiments, the bar assembly 5 may include more than one support assembly 15. In these embodiments (and others) only one bracket assembly 24 may include a rotatable joint for installing the bar assembly 5. In some embodiments, the bar assembly 5 may include a single rotatable joint in a bracket assembly and other bracket assemblies included in the bar assembly 15 may be fixed (or locked).

In particular embodiments, the one or more support assemblies 15 define a cutout 22 for the lever 40. As will be understood, the cutout 22 provides room for the lever 40 to actuate a corresponding suction cup assembly 30 and includes a mechanism for operatively coupling suction cup assembly 30 to the support bracket 24. Specifically, the lever 40 is affixed by a bracing mechanism so that it is stably secured to support bracket 24 and connects by a bolt through a hole in support bracket 24 to a metal disc that is wholly encased inside suction cup assembly 30. When the lever 40 is compressed, it creates concavity in the metal disc and concomitantly, concavity in the suction cup assembly 30, resulting in the vacuum force that creates the suction.

### Suction Cup Assembly

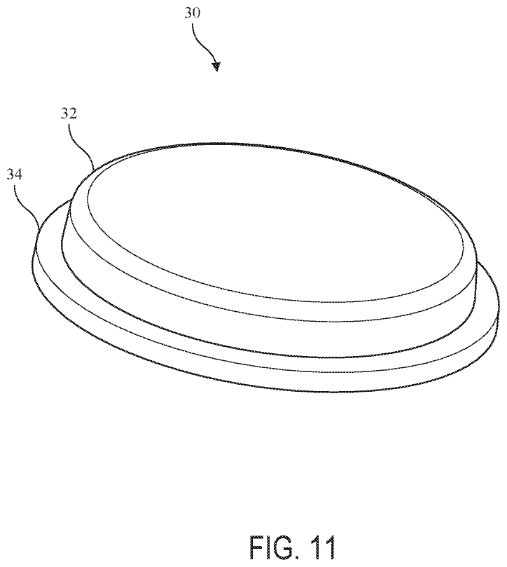

FIG. 11 shows a perspective view of the suction cup assembly 30, according to one embodiment of the present disclosure. In the embodiment shown in FIG. 11, the suction cup assembly 30 is substantially circular and comprises a suction cup 34 that is partly covered by suction cup housing 32 that is connected to support bracket 24, and in the embodiment shown in FIG. 11, is comprised of the same rigid material as support bracket 24. Not visible in FIG. 11 is the metal (or other rigid but flexible material) disc within the suction cup 34 that (a) connects the lever 40 to the suction cup assembly 30 and actuates the suction cup assembly 30 as further set forth above, and (b) is inside of and fully encased within the rubber suction cup 34. In the embodiment, the radius of the circular metal disc encased in suction cup 34 is approximately two thirds the radius of the suction cup 34 (e.g., 1.5 inches compared to 2.25 inches, respectively, 2 inches compared to 3 inches, 4 inches compared to 6 inches, etc.), but any relative dimensions that result in a functioning suction cup 34 will work. In one embodiment, the suction cup housing 32 protects the suction cup 34 from damage. In one embodiment, the suction cup housing 32 provides a surface against which the metal disc is bent to create concavity in the suction cup 34.

In particular embodiments, the suction cup assembly 30 cooperates with support surface 60 to provide sufficient suction to maintain the disclosed bar apparatus in position for a desired amount of time. Suction cup assembly 30 can be constructed from any suitable material, including (but not limited to) rubber, latex, or an equivalent flexible sealing material. In some embodiments, the suction cup assembly 30 includes with a housing 32 that includes an uninterrupted and continuous rim abutting the suction cup 34 to the interior of the peripheral edge.

In particular embodiments, the dimensions of the suction cup 34 and housing 32 are sufficient in length and circumference to provide the desired amount of suction against surface 60 to support, for example, a person during an exercise routine. In some embodiments, the suction cup 34 and cup housing 32 are substantially circular in shape as depicted in the drawings. However, the shape of the cups 34 and housing 32 are not limited and may be other suitable shapes.

### Lever

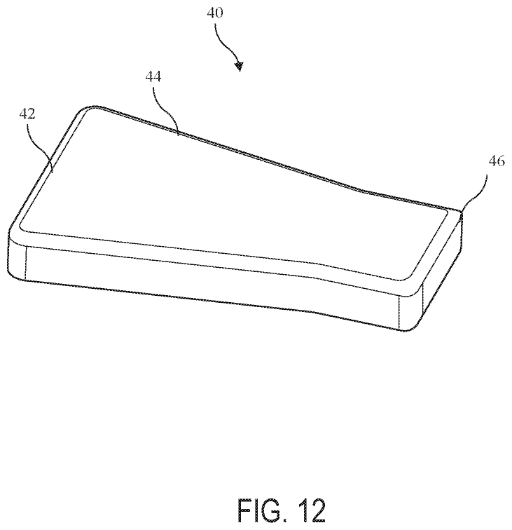

FIG. 12 shows a perspective view of the lever 40 according to one embodiment. As will be understood from discussions herein, lever 40 is pivotally mounted to the suction cup assembly 30 and configured to move through a short arc from a first position to a second position, where moving the lever 40 from the first position to the second position actuates suction cup 34.

In particular embodiments, when the suction cup assembly 30 is applied to a surface and lever 40 is actuated, air is evacuated from the cup 34 to allow the cup 34 to tightly adhere to the surface. In some embodiments, the lever mechanism creates an internal vacuum that allows each suction cup 34 to be securely and removably attached to a substantially flat surface, such as a wall. To release the suction and disengage each suction cup 34 from the surface, the user moves lever 40 in the opposite direction, thereby causing the suction cup 34 to release the suction. Once released, the assembly 30 can be removed or moved to another location where it can be attached to the new surface as desired. In the embodiment shown in FIG. 12, lever 40 is shaped such that the outside edge 42 is wider than the inside edge 46 and the long edge 44 is angled inward, to allow the user a broader surface with which to compress the lever. However, any usable shape for lever 40 that enables the user to compress and decompress lever 40 that is used in the present art is suitable.

### Installation Method

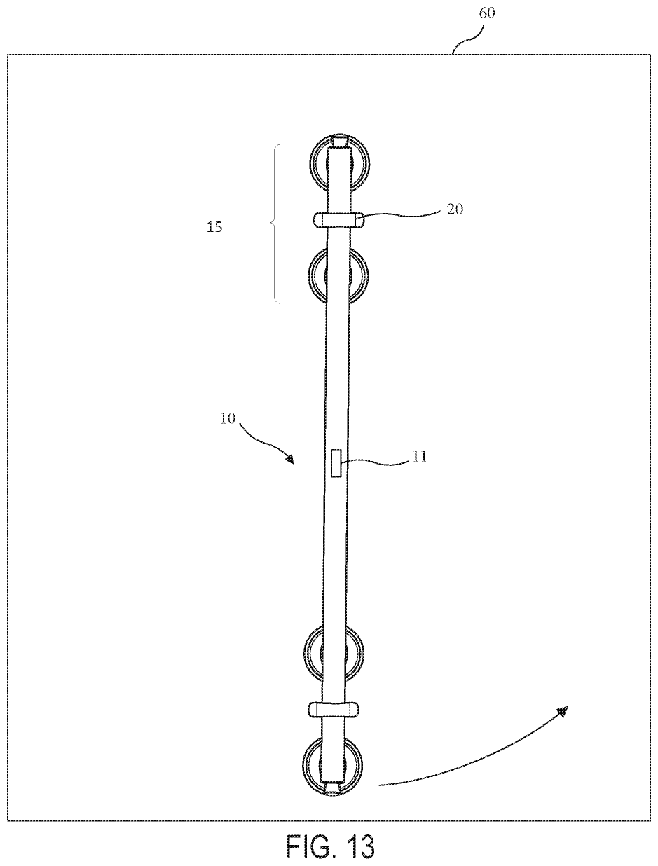

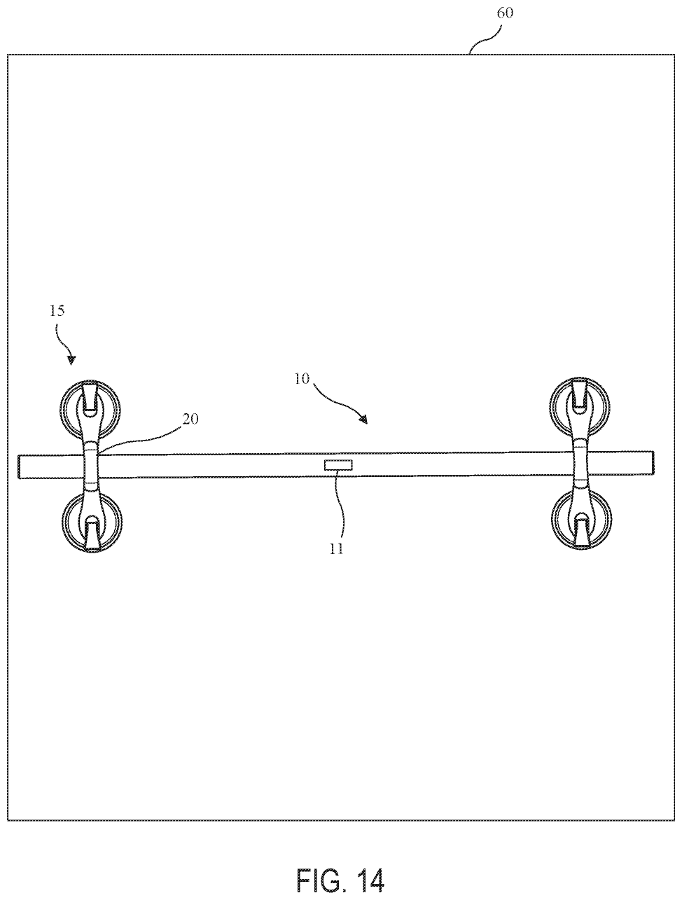

FIGS. 13 and 14 depict an exemplary installation method of the bar assembly 5. As discussed above, in various embodiments, the bar assembly 5 may be installed by attaching one or more of the suction cup assemblies 30 of one support assembly 15 of the bar assembly 5 with at least one bar-housing 26 in a rotated position, such that the bar 10 hangs vertically from a support surface support surface 60. During such installation, in particular embodiments, a second support assembly 15 of the bar assembly 5 hangs unattached to the support surface 60 (e.g., resting against a floor or other surface, or held by the user) while the first support assembly end 15 is installed, as further described below.

As shown in the embodiment in FIG. 13, the user may attach a first support assembly of the bar assembly 5 by placing both suction cup assemblies 30 of the first support assembly flush against a support surface 60, and moving the lever 40 respective to each suction cup assembly 30 in the manner described herein, such that each suction cup 34 is actuated as described herein, resulting in a secure but removable attachment to the support surface 60 for the first support assembly 15 of the bar assembly 5. In one embodiment, in which the bar assembly 5 comprises only once suction cup assembly 30 in each support assembly 15, the user may instead only move one lever 40 for each support assembly.

During installation of the first support assembly, the support assembly 15 on the other side of the bar assembly 5 may be, held, left hanging or resting on a floor or other surface. Once the first support assembly 15 is securely attached to the support surface, the user may then swing the second support assembly 15 of the bar assembly 5, as shown in the embodiment illustrated in FIG. 13, in a counterclockwise direction (or clockwise direction in some embodiments) until the second support assembly 15 is in a position desirable to the user (e.g., level with the floor as shown by the level element 11), at which point the user may attach the second support assembly end 15 to the support surface 60 by following the steps described above (by moving each lever respective to each suction cup 34 in a manner that actuates each suction cup 34 on the second support end). FIG. 14 shows the bar assembly 5 fully installed on (e.g., attached to) support surface 60 in the above manner.

### Alternate Embodiments

It should be appreciated that the presently disclosed subject matter is not limited to application in the “bane” fitness. Other exercises and exercises fields could benefit from application of the presently disclosed subject matter, such as performing pull-ups or other exercise using one's body weight or partial body weight as resistance or for stretching purposes. The presently disclosed subject matter could also be used to securely, quickly, and removably attach weights to a bar, barbell, weights, or some other apparatus for purposes of weightlifting exercises. The presently disclosed subject matter could also be used to create a support structure for band or strap based exercises and physical therapy exercises. The presently disclosed subject matter could also be used in physical rehabilitation or physical therapy settings as a movable support device.

Additionally, the disclosed support bar assembly 5 can be used in a wide variety of areas that are not related to exercise. For example, the disclosed support bar 10 can be used as a movable hand rail, grab or support bar for individuals, including for the disabled, elderly, or other individuals who may be assisted by such a device (i.e., a “soft” medical device”), as a “ballet-barre” or for application other fields of dance, for climbing smooth surfaces.

The disclosed support bar assembly 5 also may consist of less or more suction cups 34 as needed for each support assembly 15 in order to secure the bar assembly 5 to a support surface with sufficient force required by the user. The disclosed support bar assembly 5 may also consist of more support assemblies 15 as are needed to support a longer bar 10. The bar 10 could also be made longer, or could consist of multiple bars 10 that connect to multiple support assemblies 15 as are needed to support the longer bar unit.

### CONCLUSION

Aspects, features, and benefits of the claimed invention(s) will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A bar apparatus for removable attachment to a support surface, the apparatus comprising:
a. a support bar having a first end and a second end;
b. two or more suction cup assemblies, each suction cup assembly comprising:
i. a cup housing;
ii. a suction member; and
iii. a lever that disposes the cup housing against the suction member when actuated to attach the assembly to a support surface; and
c. one or more support assemblies that operatively connect the support bar to the two or more suction cup assemblies, wherein at least one support assembly comprises:
i. a rotating joint between the support bar and the two or more suction cup assemblies; and
ii. a support bracket that operatively connects the rotating joint to the two or more suction cup assemblies.

2. The apparatus of claim 1, further comprising a leveling device.

3. The apparatus of claim 2, wherein the leveling device is embedded within the support bar.

4. The apparatus of claim 1, 2, or 3, wherein the support bar is hollow.

5. The apparatus of claims 1-4, wherein the support bar is about 1-5 feet in length, 1-5 inches in diameter, or both.

6. The apparatus of claims 1-5, wherein the suction member and cup housing are substantially circular in shape.

7. The apparatus of claims 1-6, wherein the support bracket comprises a substantially v-shaped outer perimeter.

8. The apparatus of claims 1-7, wherein the support bracket comprises a substantially u-shaped interior.

9. The apparatus of claims 1-8, wherein the support bracket is constructed from wood, metal, rigid plastic, or combinations thereof.

10. The apparatus of claims 1-9, wherein the rotating joint is movable relative to the suction cup assembly.

11. The apparatus of claims 1-10, wherein the rotating joint facilitates rotation of the support bar 360 degrees relative to the suction cup assembly.

12. The apparatus of claims 1-11, wherein the one or more support assemblies are positioned proximate the first end or the second end of the support bar.

13. The apparatus of claims 1-12, wherein the at least one or more support assemblies comprise two support assemblies.

14. A method for installing a removable bar assembly comprising:
placing a suction cup of a first support assembly upon a surface, with a support bar in a first position;
actuating a lever operatively coupled to the first support assembly suction cup thereby causing air to be evacuated from the first support assembly suction cup and adhering the first support assembly suction cup to the surface;
rotating the support bar to a second position via a joint operatively connecting the support bar to the first support assembly suction cup; and
actuating a lever of a second support assembly thereby causing air be evacuated from a suction cup of the second support assembly and adhering a second suction cup to the surface, thereby adhering the support bar to the surface in the second position.

15. The method of claim 14, wherein:
the first support assembly comprises more than one suction cup; and
the method further comprises actuating one or more levers operatively coupled to the first support assembly one or more suction cups, thereby causing air to be evacuated from the first support assembly one or more suction cups and adhering the first support assembly one or more suction cups to the surface.

16. The method of claim 14 or 15, wherein:
the second support assembly comprises more than one suction cup; and
the method further comprises actuating one or more levers operatively coupled to the second support assembly one or more suction cups, thereby causing air to be evacuated from the second support assembly one or more suction cups and adhering the second support assembly one or more suction cups to the surface.

17. The method of claim 14, 15, or 16, wherein the removable bar assembly further comprises a leveling device embedded within the support bar.

18. The method of claim 17, wherein rotating the support bar to the second position further comprises determining, via the leveling device, that the support bar is parallel to the ground.

19. The method of claims 14-18, wherein the first position is approximately 90 degrees relative to the second position.

20. The method of claims 14-19, further comprising the step of testing the installed removable bar assembly to ensure that the installed removable bar assembly supports a particular amount of weight.
